(19) United States
(12) Patent Application Publication
(10) Pub. No.: US 2012/0225347 A1
(43) Pub. Date: Sep. 6, 2012

(54) SOLID BATTERY MODULE

(75) Inventor: Shinji Kojima, Nagoya-shi (JP)

(73) Assignee: TOYOTA JIDOSHA KABUSHIKI KAISHA, Toyota-shi, Aichi (JP)

(21) Appl. No.: 13/503,549

(22) PCT Filed: Nov. 26, 2009
(86) PCT No.: PCT/JP2009/069941

§ 371 Date: Apr. 23, 2012

(51) Int. Cl. H01M 10/02; H01M 2/20

(52) U.S. Cl. 429/159; 429/156

(57) ABSTRACT

A solid battery wherein a plurality of battery elements are disposed in a direction intersecting with a stacking direction of the members to constitute the battery element, and an arrangement position of the battery element can be easily determined. The solid battery module includes a plurality of battery elements each provided with a solid electrolyte layer and with a pair of cathode layer and anode layer to sandwich the solid electrolyte layer, wherein the plurality of battery elements are aligned in the direction intersecting with the stacking direction of the solid electrolyte layer, the cathode layer and the anode layer; the solid battery module includes a substrate on which to dispose the plurality of battery elements; and the substrate includes a positioning portion which determines the arrangement position of the plurality of battery elements.

### TECHNICAL FIELD

The present invention relates to a solid battery module.

### BACKGROUND ART

A Lithium-ion secondary battery has characteristics that it has a higher energy density and is operable at a high voltage compared with other secondary batteries. Therefore, it is used for information equipment such as a cellular phone, as being a secondary battery which can be easily reduced in size and weight. And in recent years there have also been increasing demands of the lithium-ion secondary battery to be used as a power source for large-scale apparatuses such as electric vehicles and hybrid vehicles.

A lithium-ion secondary battery comprises: a cathode layer; an anode layer; and an electrolyte arranged therebetween. The electrolyte is made of a nonaqueous liquid or a solid. When the nonaqueous liquid is used as the electrolyte (hereinafter the liquid being referred to as an “electrolytic solution”), the electrolytic solution permeates inside the cathode layer. Therefore, the interface between a cathode active material constituting the cathode layer and the electrolyte is easily formed; and the performance of the battery is easily improved. However, since a widely-used electrolytic solution is flammable, it is necessary to mount a system to ensure safety. On the other hand, a solid electrolyte is nonflammable, thus enabling simplification of the above system. Accordingly, there has been proposed a lithium-ion secondary battery which is provided with a layer containing the nonflammable solid electrolyte (hereinafter, the layer being referred to as a “solid electrolyte layer”; and the battery being referred to as a “solid battery”).

As techniques related to the lithium-ion secondary battery, Patent Document 1 for example discloses a sheet-shaped battery characterized in that a plurality of solid electric generating cells are disposed on a sheet having a bending property in a square pattern, the solid electric generating cells made of an electric generating element having a cathode active material, solid electrolyte, and anode active material stacked in a layer shape. In addition, Patent Document 2 discloses a lithium-ion secondary battery comprising: a planar lithium cell battery which is accommodated into a package for a cell battery and has cathode and anode current collecting materials sealed and taken to the outside of the package for the cell battery; and an outer package accommodating a plurality of lithium cell batteries stacked. Further, this Patent Document 2 discloses that: a stick-like material is passed into a hole provided to the cathode current collecting material and to the anode current collecting material of the lithium cell battery; and a plurality of the lithium cell batteries with the stick-like material passed thereinto are given pressure to be fixated with a pressure applying material and fixation material, thereafter being accommodated into the outer package.

### CITATION LIST

### Patent Literatures

Patent Document 1: Japanese Patent Application Laid-Open (JP-A) No. 2000-195482
Patent Document 2: JP-A No. 2006-339054

### SUMMARY OF THE INVENTION

### Problems to be Solved by the Invention

According to the technique disclosed in Patent Document 1, a plurality of the solid electric generating cells are disposed on the sheet having a bending property in a square pattern, the solid electric generating cells made of a cell element having a cathode active material, solid electrolyte, and anode active material stacked in a layer shape. Thus it is assumed that: the mechanical stress of the electric generating cell is prevented (or alleviated), providing high reliability to the sheet-like battery, and even if the electric generating cell is a rigid body, the sheet-like battery is given relatively uniform flexibility and deformation of the electric generating cell is prevented, thereby increasing the reliability of the sheet-like battery. However, with the technique disclosed in Patent Document 1, unfortunately it is difficult to determine the position for disposing the solid electric generating cells and to arrange them in an orderly manner. According to the technique disclosed in Patent Document 2, a plurality of lithium cell batteries are stacked by passing the stick-like material through the holes provided to the lithium cell batteries; thus it is assumed that displacement of the lithium cell batteries can be prevented. However, with the technique disclosed in Patent Document 2, although it is possible to stack the plurality of lithium cell batteries inside one outer package, the lithium cell batteries cannot be disposed in a direction intersecting with the stacking direction.

Accordingly, an object of the present invention is to provide a solid battery module wherein a plurality of battery elements are disposed in a direction intersecting with a stacking direction of the members to constitute the battery element, and an arrangement position of the battery element can be easily determined.

### Means for Solving the Problems

In order to solve the above problems, the present invention takes the following means. In specific, the present invention is a solid battery module comprising a plurality of battery elements each provided with a solid electrolyte layer and with a pair of cathode layer and anode layer to sandwich the solid electrolyte layer, wherein the plurality of battery elements are aligned in a direction intersecting with a stacking direction of the solid electrolyte layer, the cathode layer and the anode layer; the solid battery module comprises a substrate on which to dispose the plurality of battery elements; and the substrate comprises a positioning portion which determines the arrangement position of the plurality of battery elements.

In the present invention, the “battery element” refers to a structure which has at least each one of the solid electrolyte layer, cathode layer, and anode layer stacked and which is further provided with a current collector and the like thereby configured to be chargeable and dischargeable. Examples thereof include: those obtained by forming a plurality of unit cells each comprising a cathode current collector, cathode layer, solid electrolyte layer, anode layer, and anode current collector in this order; and those obtained by forming a plurality of bipolar electrodes.

In the solid battery module of the present invention, it is preferable that the adjacent battery elements share the positioning portion. With this configuration, it is possible to carry out positioning with few positioning portions, thereby enabling increase in the energy density of the battery module.

Further, in the solid battery module of the present invention, it is preferable that: the positioning portion is a stick-like structure standing from the substrate; the battery element is provided with a current collector having a protrusion portion which protrudes in the direction intersecting with the stacking direction of the solid electrolyte layer, the cathode layer, and the anode layer; the protrusion portion is provided with a hole or a cutout which corresponds to the stick-like structure; and the stick-like structure is inserted into the hole or the cutout in a manner that the protrusion portions provided to the adjacent battery elements overlap with each other. With this configuration, it is possible to electrically connect the adjacent battery elements with the current collector.

### Effects of the Invention

According to the present invention, it is possible to provide a solid battery module wherein a plurality of the battery elements are disposed in a direction intersecting with the stacking direction of the members to constitute the battery element, and the arrangement position of the battery elements can be easily determined.

### BRIEF DESCRIPTION OF THE DRAWINGS

FIG. 1 is a schematically shown plan view of a solid battery comprising the solid battery module of the present invention.

FIG. 2 is a schematic view of a cross section of the solid battery shown in FIG. 1.

FIG. 3 is a schematic view of a cross section in a direction orthogonal to the cross section shown in FIG. 2.

FIG. 4 is a schematic view illustrating a configuration of the battery element provided to the solid battery module of the present invention.

### DESCRIPTION OF THE REFERENCE NUMERALS

1 solid battery
10 solid battery module
100a, 100b, 100c battery element
101 cathode plate
101a cathode-side current collector
101b cathode layer
101c region without cathode layer of cathode plate
102 solid electrolyte layer
103 anode plate
103a anode-side current collector
103b anode layer
103c region without anode layer of anode plate
120 exterior body
120a substrate
130 joint portion
140 cathode terminal
150 anode terminal
200 positioning portion

### MODES FOR CARRYING OUT THE INVENTION

Hereinafter, the present invention will be described in detail with a lithium-ion secondary battery given as an example. It should be noted, however, that the present invention is not limited to this embodiment but can be applied to various solid batteries.

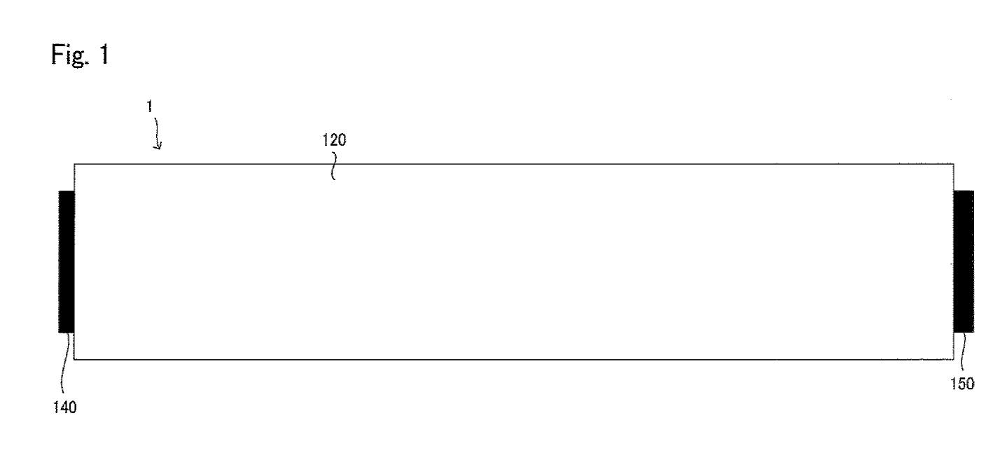

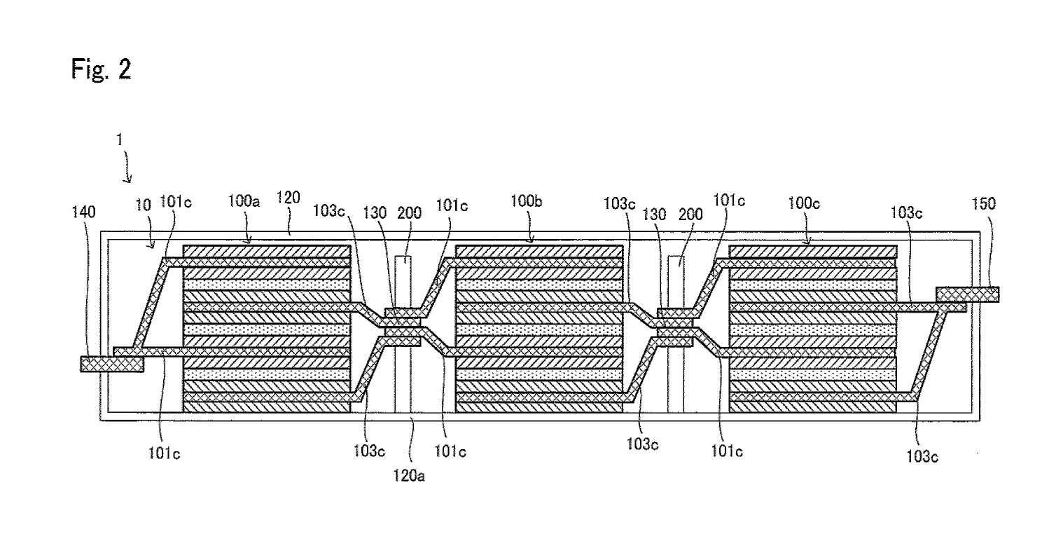

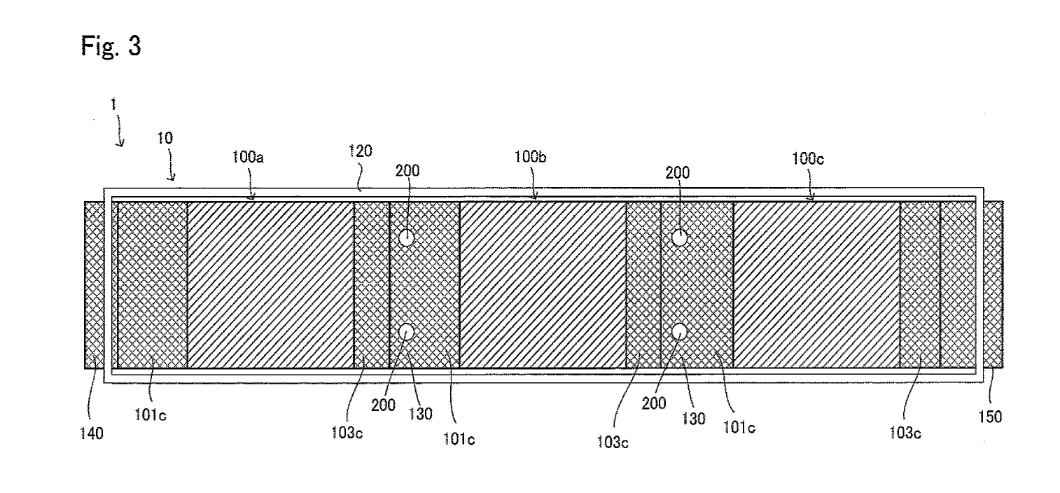

FIG. 1 is a schematically shown plan view of a solid battery 1 comprising a solid battery module 10 of the present invention. FIG. 2 is a schematic view illustrating a configuration of the solid battery module 10 of the present invention, and schematically shows a cross section of the solid battery 1 shown in FIG. 1. In FIG. 2, reference numerals are partly omitted in order to prevent the figures from being complicated. FIG. 3 is a schematic view illustrating a configuration of the solid battery module 10 of the present invention, and shows the solid battery 1 of FIG. 2 seen from the upper side of FIG. 2. It should be noted that in FIG. 3, an exterior body is partly omitted in order to make the configuration of the solid battery module 10 easy to understand.

As shown in FIG. 1, the solid battery 1 comprises the exterior body 120, and the solid battery module 10 is accommodated into the exterior body 120. A cathode terminal 140 and anode terminal 150 connected to the solid battery module 10 are arranged to protrude from both ends of the exterior body 120 (a left/right direction of the sheet of paper); and the cathode terminal 140 and the anode terminal 150 enable electrical energy to be taken to the outer area. The material, size and the like of the cathode terminal 140 and the anode terminal 150 are not particularly restricted as long as the cathode terminal 140 and the anode terminal 150 are configured to be capable of taking the electrical energy generated in the solid battery module 10 to the outer area. Hereinafter, the configuration of the solid battery module 10 will be described in detain with reference to FIGS. 2 to 4.

<Solid Battery Module 10>

As shown in FIGS. 2 and 3, the solid battery module 10 comprises a first battery element 100a, a second battery element 100b, and a third battery element 100c, which are disposed on the substrate 120a (hereinafter, the first battery element 100a, second battery element 100b, and third battery element 100c may be simply indicated as a “battery element 100” in cases where they do not need to be distinguished). These battery elements 100a, 100b, 100c are aligned in a direction intersecting with a direction for stacking the members to constitute the battery element 10 (for example, a solid electrolyte layer, cathode layer, and anode layer, which will be described below in detail). In the embodiments shown in FIGS. 2 and 3, the substrate 120a is formed by one face of the exterior body 120. However, the present invention is not limited to such a configuration; the substrate 120a may be provided separately from the exterior body 120.

Further, the adjacent battery element 100a and battery element 100b are electrically connected at a joint portion 130; and the adjacent battery element 100b and battery element 100c are also electrically connected at the joint portion 130. In addition, the arrangement positions of the battery elements 100a, 100b, 100c are determined by positioning portions 200, 200 standing from the substrate 120a. The configurations of the joint portions 130, 130 and the positioning portions 200, 200 will be described later in detail.

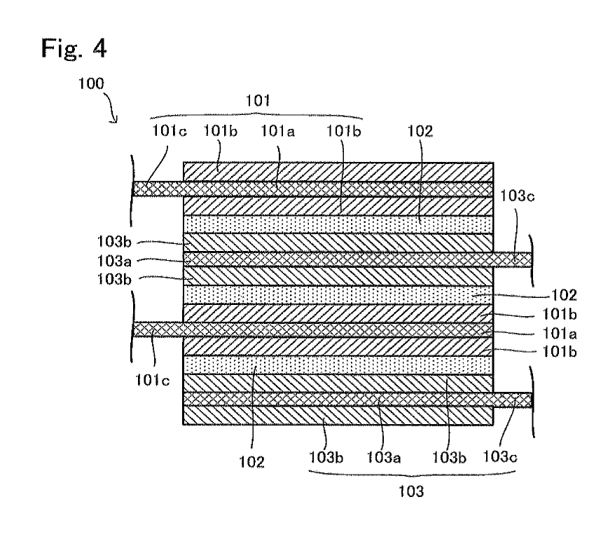

The first battery element 100a, the second battery element 100b, and the third battery element 100c have approximately the same configuration; thus, the configuration of one of the battery elements 100 will be described below with reference to FIG. 4. FIG. 4 is a schematic view illustrating the configuration of the battery element 100, and schematically shows a part of a cross section of the battery element 100.

<Battery Element 100>

As shown in FIG. 4, the battery element 100 comprises two cathode plates 101, three electrolyte layers 102, and two anode plates 103. It should be noted that in the present invention, the number of the cathode plates 101, electrolyte layers 102, and anode plates 103 is not particularly restricted, but may be suitably and adequately selected depending on the needs. For example, one cathode plate, solid electrolyte later and anode plate may be provided; or more cathode plates, solid electrolyte layers, and anode plates than shown in the embodiment in FIG. 4 may be provided.

The cathode plate 101 comprises a cathode-side current collector 101a and cathode layers 101b, 101b formed on both sides of the cathode-side current collector 101a. As shown in FIG. 4, the cathode-side current collector 101a is configured to have a protrusion portion which protrudes in one direction from a region where the cathode plate 101, electrolyte layer 102, and anode plate 103 actually overlap with one another (i.e. the direction intersecting with the direction in which the members to constitute the battery element 100 are stacked). The cathode layers 101b, 101b are formed at least in this region of the cathode-side current collector 101a where the cathode plate 101, electrolyte layer 102, and anode plate 103 overlap with one another. Further, at least a part of the protrusion portion of the cathode-side current collector 101a is kept as a region 101c without a cathode layer of a cathode plate, in which region the cathode layers 101b, 101b are not formed, the protrusion portion protruding from the region where the cathode plate 101, electrolyte layer 102, and anode plate 103 overlap with one another. This region 101c without a cathode layer of a cathode plate is connected to a cathode terminal 140 in the first battery element 100a. And in the second battery element 100b, it is connected, at the joint portion 130, to a below described region 103c without an anode layer of an anode plate, of the first battery element 100a. Further, in the third battery element 100c, it is connected, at the joint portion 130, to a below described region 103c without an anode layer of an anode plate, of the second battery element 100b.

The anode plate 103 comprises an anode-side current collector 103a and anode layers 103b, 103b formed on both sides of the anode-side current collector 103a. As shown in FIG. 4, the anode-side current collector 103a is configured to have a protrusion portion which protrudes in one direction from a region where the cathode plate 101, electrolyte layer 102, and anode plate 103 actually overlap with one another (i.e. the direction intersecting with the direction in which the members to constitute the battery element 100 are stacked). The anode layers 103b, 103b are formed at least in this region of the anode-side current collector 103a where the cathode plate 101, electrolyte layer 102, and anode plate 103 overlap with one another. Further, at least a part of the protrusion portion of the anode-side current collector 103a is kept as a region 103c without an anode layer of an anode plate, in which region the layers 103b, 103b are not formed, the protrusion portion protruding from the region where the cathode plate 101, electrolyte layer 102, and anode plate 103 overlap with one another. In the first battery element 100a, this region 103c without an anode layer of an anode plate is connected, at the joint portion 130, to the region 101c without a cathode layer of a cathode plate, of the second battery element 100b. And in the second battery element 100b, it is connected, at the joint portion 130, to the region 101c without a cathode layer of a cathode plate, of the third battery element 100c. Further, in the third battery element 100c, it is connected to the anode terminal 150.

In this manner, the solid battery module 10 has a plurality of battery elements 100a, 100b, 100c connected in series inside one exterior body (cell) 120, and thus is configured to be capable of improving the energy density and power density, compared with a case of connecting between cells. In addition, since the number of components for connecting between cells is reduced, it is possible reduce costs and the number of working processes. It should be noted that although FIGS. 2 and 3 show the example that three battery elements are provided, the present invention is not limited to this embodiment. Two battery elements may be provided, or 4 or more battery elements may be provided. Hereinafter, a structure of the layers mainly provided to the battery element 100 will be described in more detail.

(Cathode Layer 101b, Anode Layer 103b)

The cathode layer 101b and the anode layer 103b are layers containing an active material and a solid electrolyte and optionally containing a conductive additive and a binder. When the battery element 100 is a lithium secondary battery, examples of the active material include: lithium cobalt oxide (LiCoO₂); lithium nickel oxide (LiNiO₂); Li₁₊ₓNi_{1/3}Mn_{1/3}Co_{1/3}O₂; lithium manganese oxide (LiMn₂O₄); different-element substituted Li—Mn spinel represented by Li₁₊ₓMn_{2-x-y}M_{y}O₄ (wherein, M is any one of Al, Mg, Co, Fe, Ni, Zn etc.); lithium titanate (LiₓTiO_{y}); lithium phosphate (LiMPO₄ wherein, M is any one of Fe, Mn, Co, Ni etc.); vanadium oxide (V₂O₅), molybdenum oxide (MoO₃), titanium sulfide (TiS₂), which are transition metal compounds; a carbon (C) material such as graphite and hard carbon; lithium cobalt nitride (LiCoN); lithium silicon oxide (LiₓSi_{y}O_{z}); a lithium (Li) metal or a lithium alloy (LiM: M is any one of Sn, Si, Al, Ge, Sb, P etc.); a lithium storage intermetallic compound (MgₓM: M is any one of Sn, Ge, Sb etc.; or N_{y}Sb: N is any one of In, Cu, Mn etc.); and derivatives thereof. Here, there is not a clear distinction between the cathode active material and the anode active material. Thus, comparing a charge-discharge potential of two kinds of compounds, one showing a noble potential may be used for the cathode layer 101b and the other showing a base potential may be used for the anode layer 103b; thereby it is possible to compose a lithium secondary battery having an arbitrary voltage.

Further, when the battery element 100 is a lithium secondary battery, the following may be used as the solid electrolyte: an amorphous oxide solid electrolyte such as Li₂O—B₂O₃—P₂O₅, Li₂O—SiO₂, Li₂O—B₂O₃—ZnO; an amorphous sulfide solid electrolyte such as Li₂S—SiS₂, LiI—Li₂S—SiS₂, LiI—Li₂S—P₂S₅, LiI—Li₂S—B₂S₃, Li₃PO₄—Li₂S—Si₂S, Li₃PO₄—Li₂S—SiS₂, LiPO₄—Li₂S—SiS, LiI—Li₂S—P₂O₅, LiI—Li₃PO₄—P₂S₅, Li₂S—P₂S₅; LiI, LiI—Al₂O₃, Li₃N, Li₃N—LiI—LiOH; or crystalline oxide and oxynitride such as Li_{1.3}Al_{0.3}Ti_{0.7}(PO₄)₃, Li_{1+x+y}AₓTi₂₋ₓSi_{y}P_{3-y})₁₂ (A is Al or Ga; 0≦x≦0.4, 0<y≦0.6), [(B_{1/2}Li_{1/2})_{1-z}C_{z}]TiO₃ (B is any one of La, Pr, Nd, Sm; C is Sr or Ba; 0≦z≦0.5), Li₅La₃Ta₂O₁₂, Li₇La₃Zr₂O₁₂, Li₆BaLa₂Ta₂O₁₂, Li₃PO_{(4-3/2w)}N_{w} (w<1), Li_{3.6}Si_{0.6}P_{0.4}O₄.

As to the conductive additive, a conventional one may be used without any particular restrictions; for example, a carbon material such as acetylene black is preferably used. As to the binder as well, a conventional one may be used without any particular restrictions; for example, a fluorine resin such as polyvinylidene fluoride and a rubber-type resin such as styrene-butadiene rubber (SBR) are preferably used. The mixing ratio of each of the materials to be contained in the cathode layer 101b and anode layer 103b is not particularly restricted as long as it enables appropriate operation of the battery element 100.

Further, the thickness, shape and the like of the cathode layer 101b and anode layer 103b are not particularly restricted as long as the cathode layer 101b and anode layer 103b are appropriately formed on the cathode-side current collector 101a and the anode-side current collector 103b, respectively; and the production method thereof is also not particularly restricted. As for the production method of the cathode layer 101b, for example, a cathode paste containing the above described active material and solid electrolyte and optionally containing the conductive additive and the binder is applied and dried on the cathode-side current collector 101a; thereby the cathode layer 101b can be produced. A method of applying the cathode paste is not particularly restricted; for example, a doctor blade or the like may be used to apply it. As for the production method of the anode layer 103b, for example, an anode paste containing the above described active material and solid electrolyte and optionally containing the conductive additive and the binder is applied and dried on the anode-side current collector 103a; thereby the anode layer 103b can be produced. A method of applying the anode paste is not particularly restricted; for example, a doctor blade or the like may be used to apply it.

(Solid Electrolyte Layer 102)

The solid electrolyte layer 102 is a layer containing a solid electrolyte and optionally containing the binder and the like. As to the solid electrolyte, the above described solid electrolyte may be used. As to the binder as well, those described above may be used. The mixing ratio of each of the materials to be contained in the solid electrolyte layer 102 is not particularly restricted as long as it enables appropriate operation of the battery element 100.

Further, the thickness, shape and the like of the solid electrolyte 102 are not particularly restricted as long as the solid electrolyte 102 is appropriately disposed between the cathode layer 101b and the anode layer 103b and can contribute to ion conduction between the cathode layer 101b and the anode layer 103b; and the production method thereof is also not particularly restricted. As for the production method of the solid electrolyte layer 102, for example, a solid electrolyte paste containing the above described solid electrolyte is applied onto the cathode layer 101b to be dried; thereby the solid electrolyte layer 102 can be produced. After that, the anode current collector 102a having the anode layer 103b formed is stacked on the solid electrolyte layer 102 in a manner that the solid electrolyte layer 102 is sandwiched by the cathode layer 101b and the anode layer 103b, to be subjected to a pressing treatment. It should be noted that the solid electrolyte layer 102 may also be formed on the anode layer 103b, then stacking the cathode current collector 101a having the cathode layer 101b formed. Furthermore, the solid electrolyte layer 102 may also be formed on the surface of the cathode layer 101b and the surface of the anode layer 103b. In addition to these configurations, the solid electrolyte layer 102 produced separately may be sandwiched by the cathode layer 101b and the anode layer 103b. However, in order to easily provide a solid battery with an improved performance, the solid electrolyte layer 102 is preferably disposed on the surface of the cathode layer 101b and the anode layer 103b.

(Cathode-Side Current Collector 101a, Anode-Side Current Collector 103a)

The material and the like of the cathode-side current collector 101a and the anode-side current collector 103a are not particularly restricted as long as the cathode-side current collector 101a and the anode-side current collector 103a can be used for a solid battery. For example, a metal foil and the like having a thickness of approximately 10 to 500 μm may be used. Specific examples include: a metal foil such as stainless steel, Cu, Ni, V, Au, Pt, Al, Mg, Fe, Ti, Co, Zn, Ge, In, Li, and a material obtained by vapor-depositing metal such as Cu, Ni, V, Al, Pt, Au onto a film of polyamide, polyimide, PET, PPS, polypropylene etc, glass, silicon plate and the like. The thickness and size of the current collector are not particularly restricted.

(Positioning Portion 200)

The positioning portion 200 is a stick-like structure standing from the substrate 120a. As described above, the cathode-side current collector 101a and the anode-side current collector 103a provided to the battery element 100 comprises a portion protruding in the direction intersecting with the stacking direction of the members to constitute the battery element 100 (the stacking direction being the top and bottom direction in FIG. 2; the intersecting direction being the left and right direction in FIG. 2; and the protruding portion referring to the region 101c without a cathode layer of a cathode plate, and the region 103c without an anode layer of an anode plate.). By providing a hole or a cutout corresponding to the positioning portion 200, to the region 101c without a cathode layer of a cathode plate and to the region 103c without an anode layer of an anode plate, the positioning portion 200 can be inserted into the hole or the cutout to determine the arrangement position of the battery element 100.

FIGS. 2 and 3 show a configuration in which the adjacent battery elements 100, 100 share the positioning portion 200. However, the present invention is not limited to this configuration; but each battery element may be provided with the positioning portion corresponding thereto. It should be noted that in order to be able to carry out positioning with few positioning portions and to increase the energy density of the battery module, it is preferable that the adjacent battery elements share the positioning portion.

Further, the positioning portion is not limited to the stick-like structure standing from the substrate; it may be any as long as it can determine the arrangement position of the battery element. In specific, it is possible that a recess portion corresponding to the shape of the battery element is provided to the substrate to fit the battery element into the recess portion.

(Joint Portion 130)

In the solid battery module 10 shown in FIGS. 2 and 3, the region 101c without a cathode layer of a cathode plate and the region 103c without an anode layer of an anode plate, of the adjacent battery elements 100, 100 are disposed at the joint portion 130 in a manner that they alternately overlap with each other. With this configuration, the adjacent battery elements can be electrically connected by means of the current collector. However, the present invention is not limited to this configuration, and it is satisfactory as long as the adjacent battery elements 100, 100 are electrically connected.

The invention has been described above as to the embodiment which is supposed to be practical as well as preferable at present. However, it should be understood that the invention is not limited to the embodiment disclosed in the specification and can be appropriately modified within the range that does not depart from the gist or spirit of the invention, which can be read from the appended claims and the overall specification, and a solid battery module with such modifications are also encompassed within the technical range of the invention.

### INDUSTRIAL APPLICABILITY

The present invention can be suitably used as a power source for portable appliances, electric vehicles, hybrid vehicles and the like.

1. A solid battery module comprising a plurality of battery elements each provided with a solid electrolyte layer and with a pair of cathode layer and anode layer to sandwich the solid electrolyte layer,
wherein the plurality of battery elements are arranged in a direction intersecting with a stacking direction of the solid electrolyte layer, the cathode layer and the anode layer;
the solid battery module comprises a substrate on which to dispose the plurality of battery elements;
the substrate comprises a positioning portion which determines the arrangement position of the plurality of battery elements; and
the adjacent battery elements share the positioning portion.

2. (canceled)

3. The solid battery module according to claim 1, wherein the positioning portion is a stick-like structure standing from the substrate;
the battery element is provided with a current collector comprising a protrusion portion which protrudes in the direction intersecting with the stacking direction of the solid electrolyte layer, the cathode layer, and the anode layer;
the protrusion portion is provided with a hole or a cutout which corresponds to the stick-like structure; and
the stick-like structure is inserted into the hole or the cutout in a manner that the protrusion portions provided to the adjacent battery elements overlap with each other.

4. The solid battery module according to claim 1, wherein the plurality of battery elements are accommodated into one exterior body; and
the plurality of battery elements are electrically connected within the one exterior body.

5. The solid battery module according to claim 3, wherein the plurality of battery elements are accommodated into one exterior body; and
the plurality of battery elements are electrically connected within the one exterior body.
